(19) United States
(12) Patent Application Publication
(10) Pub. No.: US 2008/0055721 A1
(43) Pub. Date: Mar. 6, 2008

(54) Light Recycling System with an Inorganic, Dielectric Grid Polarizer

(76) Inventors: Raymond T. Perkins, Orem, UT (US); Bin Wang, Orem, UT (US); Eric Gardner, Eagle Mountain, UT (US); Douglas P. Hansen, Spanish Fork, UT (US)

Correspondence Address: THORPE NORTH & WESTERN, LLP., 8180 SOUTH 700 EAST, SUITE 350, SANDY, UT, 84070, US

(21) Appl. No.: 11/469,253

(22) Filed: Aug. 31, 2006

(51) Int. Cl. G02B 5/30

(52) U.S. Cl. 359/486

(57) ABSTRACT

A light recycling system includes a light source capable of producing a visible light beam. An inorganic, dielectric grid polarizing beam splitter is disposable in the light beam to separate the light beam into two light beams of orthogonal polarization orientation including a transmitted beam and a reflected beam. The grid polarizer includes a stack of film layers disposed over the substrate. Each film layer is formed of a material that is both inorganic and dielectric. Adjacent film layers have different refractive indices. At least one of the film layers is discontinuous to form a form birefringent layer with an array of parallel ribs with a period less than approximately 260 nm. Light reorientation means is disposable in the transmitted or reflected beam for changing the polarization orientation of the transmitted or reflected beam.

### RELATED APPLICATIONS

This is related to U.S. patent application Ser. No. ______, filed Aug. 31, 2006, entitled “Inorganic, Dielectric Grid Polarizer” as attorney docket no. 00546-32517.A; U.S. patent application Ser. No. ______, filed Aug. 31, 2006, entitled “Projection Display with an Inorganic, Dielectric Grid Polarizer” as attorney docket no. 00546-32517.B; U.S. patent application Ser. No. ______, filed Aug. 31, 2006, entitled “Optical Data Storage System with an Inorganic, Dielectric Grid Polarizer” as attorney docket no. 00546-32517.C; U.S. patent application Ser. No. ______, filed Aug. 31, 2006, entitled “Optical Polarization Beam Combiner/Splitter with an Inorganic, Dielectric Grid Polarizer” as attorney docket no. 00546-32517.E which are herein incorporated by reference.

### BACKGROUND

1. Field of the Invention

The present invention relates generally to a light recycling system with an inorganic, dielectric grid polarizer or polarizing beam splitter.

2. Related Art

Various types of polarizers or polarizing beam splitters (PBS) have been developed for polarizing light, or separating orthogonal polarization orientations of light. A MacNeille PBS is based upon achieving Brewster's angle behavior at the thin film interface along the diagonal of the high refractive index cube in which it is constructed. Such MacNeille PBSs generate no astigmatism, but have a narrow acceptance angle, and have significant cost and weight.

Another polarizing film includes hundreds of layers of polymer material stretched to make the films birefringent. Such stretched films have relatively high transmission contrast, but not reflection contrast. In addition, polymer materials are organic and not as capable of withstanding higher temperatures or higher energy flux. For example, see Vikuiti™ polarizing films by 3M.

Visible light wire-grid polarizers or polarizing beam splitters have been developed and successfully incorporated into rear projection monitors or televisions. For example, see U.S. Pat. Nos. 6,234,634 and 6,447,120. A wire-grid polarizer can have an array of parallel conductive wires with a period less than the wavelength of visible light. The conductive metal of the wires, however, can absorb light.

Composite wire-grid polarizers have been proposed in which the wires include alternating layers of dielectric and conductive layers. For example, see U.S. Pat. Nos. 6,532,111; 6,665,119 and 6,788,461. Such polarizers, however, still have conductive materials.

Polarizing beam splitters have been proposed for the infrared wavelengths (1300-1500 nm), but such beam splitters are formed of material that absorb visible light, and thus are inoperable in the visible spectrum. See R.-C. Tyan, P.-C. Sun, and Y. Fainman, “Polarizing beam splitters constructed of form-birefringent multilayer gratings”, SPIE Proceedings: Diffractive and Holographic Optics Technology III, Vol. 2689, 82-89 (1996).

### SUMMARY OF THE INVENTION

It has been recognized that it would be advantageous to develop a polarizer or polarizing beam splitter that has high contrast in reflection and/or transmission, can withstand high temperatures and/or high energy flux, and that is simpler to manufacture. In addition, it has been recognized that it would be advantageous to develop a polarizer that is inorganic and dielectric. Furthermore, it has been recognized that it would be advantageous to develop a light recycling system utilizing such a polarizer or polarizing beam splitter.

The invention provides a light recycling system with a light source capable of producing a visible light beam. An inorganic, dielectric grid polarizing beam splitter is disposable in the light beam to separate the light beam into two light beams of orthogonal polarization orientation including a transmitted beam and a reflected beam. The grid plarizer includes a stack of film layers disposed over a substrate. Each film layer being formed of a material that is both inorganic and dielectric. Adjacent film layers have different refractive indices. At least one of the film layers is discontinuous to form a form birefringent layer with an array of parallel ribs with a period less than approximately 260 nm.

In accordance with one aspect of the present invention, light reorientation means is disposable in the transmitted or reflected beam for changing the polarization orientation of the transmitted or reflected beam.

In accordance with another aspect of the present invention, light combination means is disposable in the transmitted or reflected beam for changing a direction of the transmitted or reflected beam so that both the transmitted beam and the reflected beam are combined and have the same direction.

In accordance with another aspect of the present invention, both light reorientation means and light combination means are included.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a cross-sectional schematic side view of an inorganic, dielectric grid polarizer or polarizing beam splitter in accordance with an embodiment of the present invention;

FIG. 2 is a cross-sectional schematic side view of another inorganic, dielectric grid polarizer or polarizing beam splitter in accordance with another embodiment of the present invention;

FIG. 3 is a cross-sectional schematic side view of another inorganic, dielectric grid polarizer or polarizing beam splitter in accordance with another embodiment of the present invention;

FIG. 4 is a cross-sectional schematic side view of another inorganic, dielectric grid polarizer or polarizing beam splitter in accordance with another embodiment of the present invention;

FIG. 5 is a cross-sectional schematic side view of another inorganic, dielectric grid polarizer or polarizing beam splitter in accordance with another embodiment of the present invention;

FIG. 6 is a cross-sectional schematic side view of another inorganic, dielectric grid polarizer or polarizing beam splitter in accordance with another embodiment of the present invention;

FIG. 7 is a schematic view of a method for making the polarizer or polarizing beam splitter of FIG. 1 (or FIG. 4 or 5 or 6);

FIG. 8 is a schematic view of a method for making the polarizer or polarizing beam splitter of FIG. 2 (or FIG. 3);

FIGS. 9a-c are schematic side views of examples of the inorganic, dielectric grid polarizers of FIG. 1;

FIG. 10 is a schematic view of a projection display system in accordance with an embodiment of the present invention;

FIG. 11 is a schematic view of a modulation optical system in accordance with an embodiment of the present invention;

FIG. 12 is a schematic view of a projection display system in accordance with an embodiment of the present invention;

FIG. 13 is a schematic view of a projection display system in accordance with an embodiment of the present invention;

FIG. 14 is a schematic view of another projection display system in accordance with an embodiment of the present invention;

FIG. 15 is a schematic view of another projection display system in accordance with an embodiment of the present invention;

FIG. 16 is a schematic view of another modulation optical system in accordance with an embodiment of the present invention;

FIG. 17 is a cross-sectional schematic side view of another inorganic, dielectric grid polarizer or polarizing beam splitter in accordance with another embodiment of the present invention;

FIGS. 18a and 18b are schematic views of a combiner and a splitter in accordance with an embodiment of the present invention;

FIG. 19 is a cross-sectional schematic side view of another inorganic, dielectric grid polarizer or polarizing beam splitter in accordance with another embodiment of the present invention;

FIG. 20 is a schematic view of an optical storage system in accordance with an embodiment of the present invention; and

FIGS. 21a-d are schematic views light recycling systems using a grid polarizer in accordance with an embodiment of the present invention.

Various features in the figures have been exaggerated for clarity.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The terms polarizer and polarizing beam splitter are used interchangeably herein.

The term dielectric is used herein to mean non-metallic.

### Description

It has been recognized that wire-grid polarizers can provide enhanced performance or contrast to projection display systems, such as rear projection display systems. In addition, it has been recognized that that the conductive wires of a wire-grid polarizer can absorb light and can heat-up. Furthermore, it has been recognized that multi-layer stretched film polarizers are difficult to fabricate.

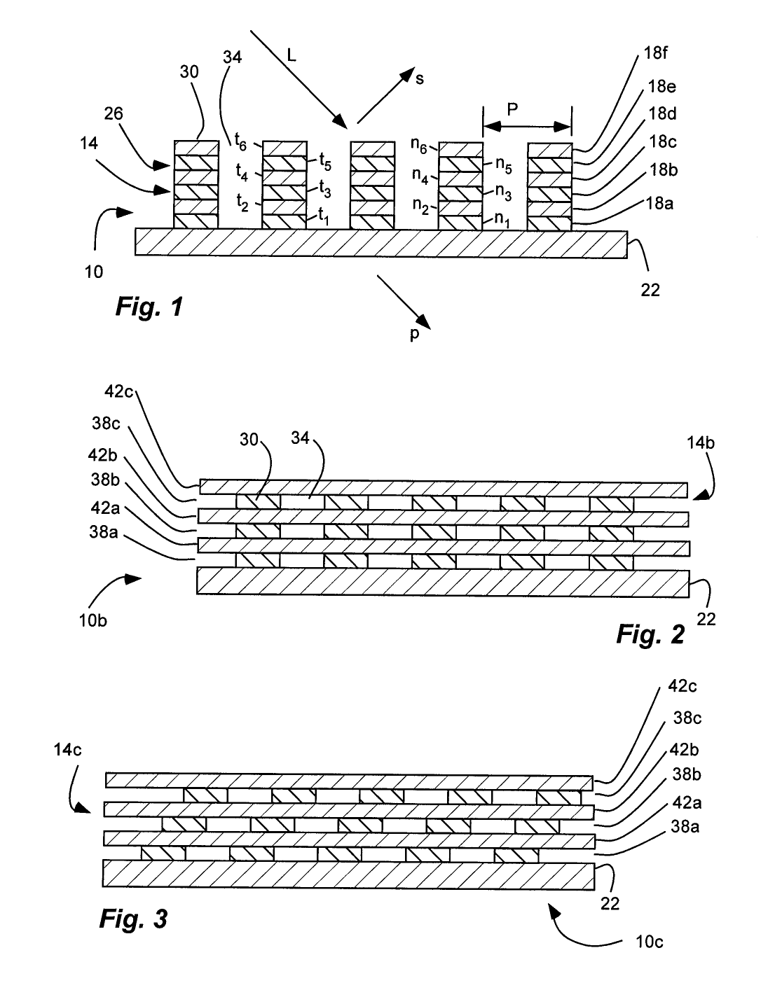

As illustrated in FIG. 1, an inorganic, dielectric grid polarizer, or polarizing beam splitter, indicated generally at 10, is shown in an exemplary implementation in accordance with the present invention. The polarizer 10 can include a stack 14 of film layers 18a-18f disposed over a substrate 22. The substrate 22 can be formed of an inorganic and dielectric material, such as BK7 glass. In addition, the film layers 18a-18f, and thus the stack 14, can be formed of inorganic and dielectric materials. Thus, the entire polarizer can be inorganic and dielectric, or formed of only inorganic and dielectric materials.

In addition, the dielectric material can further be optically transmissive with respect to the incident light. Furthermore, the dielectric material can further have negligible absorption. Thus, the light incident on the grid polarizer is not absorbed, but reflected and transmitted.

The material of each film layer can have a refractive index n. Adjacent film layers have different refractive indices (n₁≠n₂). In one aspect, film layers alternate between higher and lower refractive indices (for example n₁<n₂>n₃; n₁>n₂<n₃; n₁<n₂<n₃ or n₁>n₂>n₃). In addition, the first film layer 18a can have a different refractive index n₁ than the refractive index nₛ of the substrate 22 (n₁≠nₛ). The stack of film layers can have a basic pattern of two or more layers with two or more reflective indices, two or more different thicknesses, and two or more different materials. This basic pattern can be repeated.

In addition, the thickness of each layer can be tailored to transmit substantially all light of p-polarization orientation, and to reflect substantially all light of s-polarization orientation. Therefore, while the thicknesses t₁₋₆ shown in the figures are the same, it will be appreciated that they can be different.

While the stack 14 is shown with six film layers 18a-f, it will be appreciated that the number of film layers in the stack can vary. In one aspect, the stack can have between three and twenty layers. It is believed that less than twenty layers can achieve the desired polarization. In addition, while the film layers are shown as having the same thickness, it will be appreciated that the thicknesses of the film layers can very, or can be different. The thickness of all the film layers in the stack over the substrate can be less than 2 micrometers.

At least one of the film layers is discontinuous to form a form birefringent layer with an array 26 of parallel ribs 30. The ribs have a pitch or period P less than the wavelength being treated, and in one aspect less than half the wavelength being treated. For visible light applications (λ≈400-700 nm), such as projection display systems, the ribs can have a pitch or period less than 0.35 microns or micrometers (0.35 μm or 350 nm) for visible red light (λ≈700 nm) in one aspect; or less than 0.20 microns or micrometers (0.20 μm or 200 nm) for all visible light in another aspect. For infrared applications (λ≈1300-1500 nm), such as telecommunication systems, the ribs can have a pitch or period less than 0.75 micron or micrometer (0.75 μm or 750 nm) in one aspect, or less than 0.4 microns or micrometers (0.40 μm or 400 nm) in another aspect. Thus, an incident light beam L incident on the polarizer 10 separates the light into two orthogonal polarization orientations, with light having s-polarization orientation (polarization orientation oriented parallel to the length of the ribs) being reflected, and light having p-polarization orientation (polarization orientation oriented perpendicular to the length of the ribs) being transmitted or passed. (It is of course understood that the separation, or reflection and transmission, may not be perfect and that there may be losses or amounts of undesired polarization orientation either reflected and/or transmitted.) In addition, it will be noted that the array or grid of ribs with a pitch less than about half the wavelength of light does not act like a diffraction grating (which has a pitch about half the wavelength of light). Thus, the grid polarizer avoids diffraction. Furthermore, it is believed that such periods also avoid resonant effects or anomalies.

As shown in FIG. 1, all of the film layers are discontinuous and form the array 26 of parallel ribs 30. The ribs 30 can be separated by intervening grooves 34 or troughs. In this case, the grooves 34 extend through all the film layers 18a-18f to the substrate 22. Thus, each rib 30 is formed of a plurality of layers. In addition, all the film layers are form birefringent. As discussed below, such a configuration can facilitate manufacture.

The grooves 34 can be unfilled, or filed with air (n=1). Alternatively, the grooves 34 can be filled with a material that is optically transmissive with respect to the incident light.

In one aspect, a thickness of all the film layers in the stack over the substrate is less than 2 microns. Thus, the grid polarizer 10 can be thin for compact applications, and can be thinner than many multi-layered stretched film polarizers that have hundreds of layers.

It is believed that the birefringent characteristic of the film layers, and the different refractive indices of adjacent film layers, causes the grid polarizer 10 to substantially separate polarization orientations of incident light, substantially reflecting light of s-polarization orientation, and substantially transmitting or passing light of p-polarization orientation. In addition, it is believed that the number of film layers, thickness of the film layers, and refractive indices of the film layers can be adjusted to vary the performance characteristics of the grid polarizer.

Referring to FIG. 2, another inorganic, dielectric grid polarizer, or polarizing beam splitter, indicated generally at 10b, is shown in an exemplary implementation in accordance with the present invention. The above description is incorporated by reference. The polarizer 10b includes a stack 14b of both discontinuous layers 38a-38c and continuous layers 42a-42c. In one aspect, the discontinuous and continuous layers can alternate, as shown. Having one or more continuous layers can provide structural support to the grid, particularly if the ribs are tall. In another aspect, the ribs of one layer can be aligned with the ribs of another layer as shown. Alternatively, a polarizer 10c can have the ribs of one layer be off-set with respect to the ribs of another layer, as shown in FIG. 3. It is believed that the ribs can be aligned or off-set in order to tune or configure the grid polarizer 10b or 10c for a particular angle of incidence. For example, aligned ribs may be better suited for normal incident light, while the off-set ribs may be better suited for angled incident light.

In one aspect, the continuous layers can be formed of a material that is naturally birefringent, as opposed to form birefringent. Thus, the entire stack of thin film layers can be birefringent, without having to form ribs in the layers of naturally birefringent material.

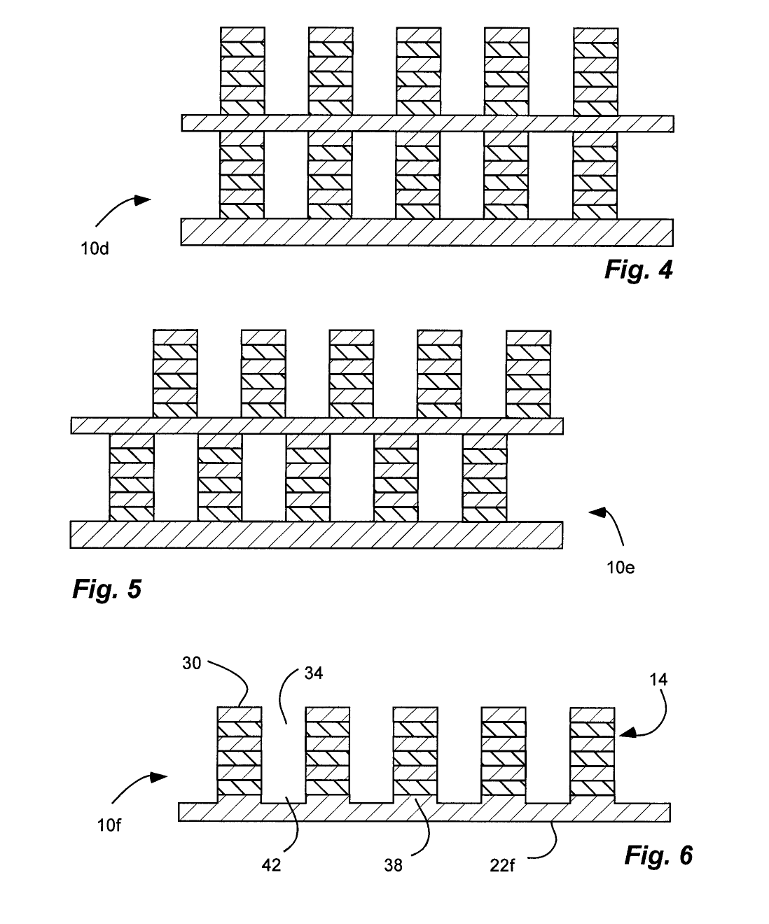

Referring to FIGS. 4 and 5, other inorganic, dielectric grid polarizers or polarizing beam splitters, indicated generally at 10d and 10e, are shown in exemplary implementations in accordance with the present invention. The above description is incorporated by reference. The polarizer 10d can have multiple discontinuous layers separate by one or more continuous layers. In addition, the polarizer 10d can be similar to two polarizers described in FIG. 1 stacked one atop the other. The ribs can be aligned as in FIG. 4, or offset as in FIG. 5.

Referring to FIG. 6, another inorganic, dielectric grid polarizer, or polarizing beam splitter, indicated generally at 10f, is shown in an exemplary implementation in accordance with the present invention. The above description is incorporated by reference. The polarizer includes a plurality of ribs 38 formed in and extending from the substrate 22f itself. Thus, the ribs 30 formed in the film layers or the stack 14 of film layers can be disposed over or carried by the ribs 38 of the substrate. The ribs 38 of the substrate can define intervening grooves or troughs 42 that can be aligned with the grooves 34 of the film layers. With this configuration, a portion of the substrate 22f can form a form birefringent layer. The ribs 38 or grooves 42 can be formed by etching the substrate 22f, such as by over-etching the above layers.

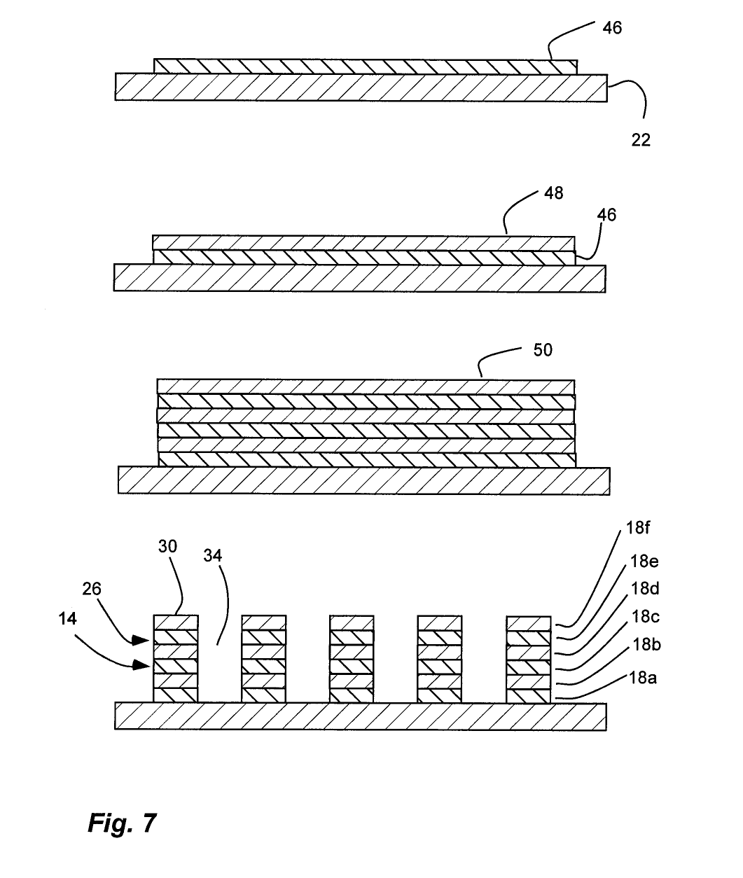

Referring to FIG. 7, a method is illustrated for forming an inorganic, dielectric grid polarizer, such as those shown in FIGS. 1, 4, 5 or 6. A substrate 22 is obtained or provided. As described above, the substrate 22 can be BK7 glass. In one aspect, the substrate is transparent to the desired wavelength of electromagnetic radiation. The substrate may be cleaned and otherwise prepared. A first continuous layer 46 is formed over the substrate 22 with a first inorganic, dielectric material having a first refractive index. A second continuous layer 48 is formed over the first continuous layer 46 with a second inorganic, dielectric material having a second refractive index. Subsequent continuous layers 50 can be formed over the second layer. The first and second layers 46 and 48, as well as the subsequent layers, can be formed by deposition, chemical vapor deposition, spin coating, etc., as is known in the art. The continuous layers, or at least one of the first or second continuous layers, are patterned to create a discontinuous layer 18a or 18b with an array of parallel ribs 30 defining at least one form birefringent layer. In addition, all the continuous layers can be patterned to create all discontinuous layers 18a-f. The layers can be patterned by etching, etc., as is known in the art.

The grid polarizer can be disposed in a beam of light and can reflect light of substantially s-polarization orientation and transmit light of substantially p-polarization orientation.

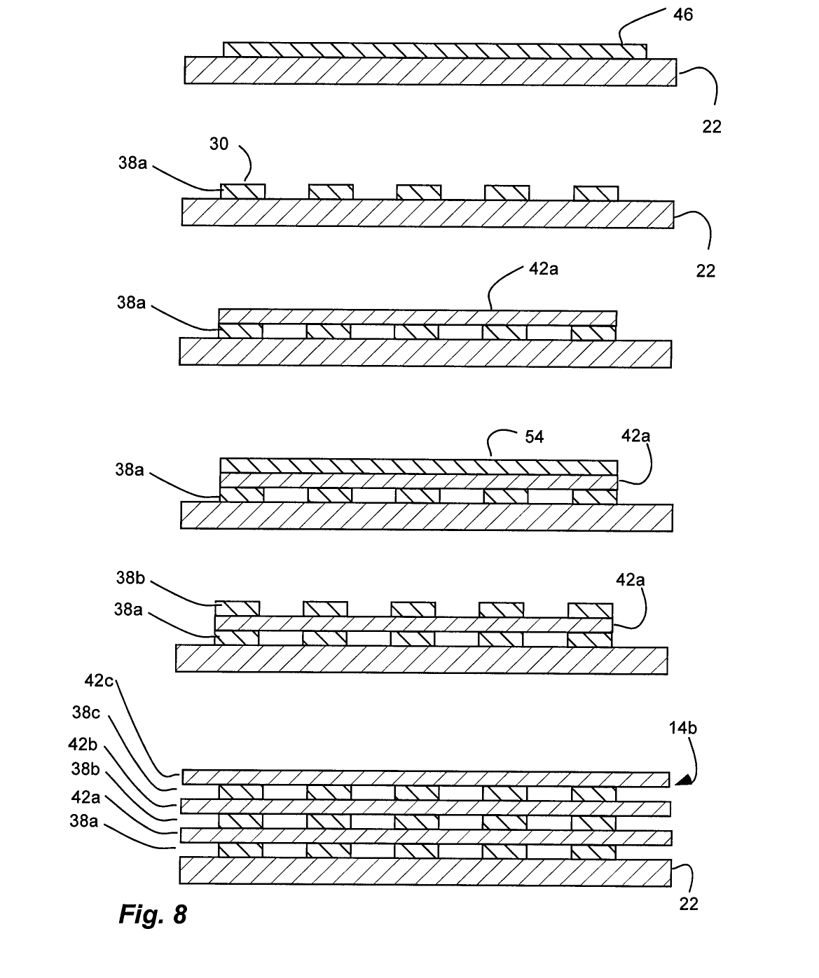

Referring to FIG. 8, another method is illustrated for forming an inorganic, dielectric grid polarizer, such as those shown in FIGS. 2, 3, 4 or 5. The method is similar to the method described above which incorporated by reference. A substrate 22 is obtained or provided. A first continuous layer 46 is formed over the substrate 22 with a first inorganic, dielectric material having a first refractive index. The first continuous layer 46 can be patterned to create a discontinuous layer 38a with an array of parallel ribs 30 defining at least one form birefringent layer. A second continuous layer 42a is formed over the first discontinuous layer 38a with a second inorganic, dielectric material having a second refractive index. Another continuous layers 54 can be formed over the second layer, and patterned to form a second discontinuous layer 38b. Thus, patterning includes patterning less than all of the layers so that at least two adjacent layers include a continuous layer and a discontinuous layer.

In another aspect, the second continuous layer can be formed over the first, and the second continuous layer patterned.

### EXAMPLE 1

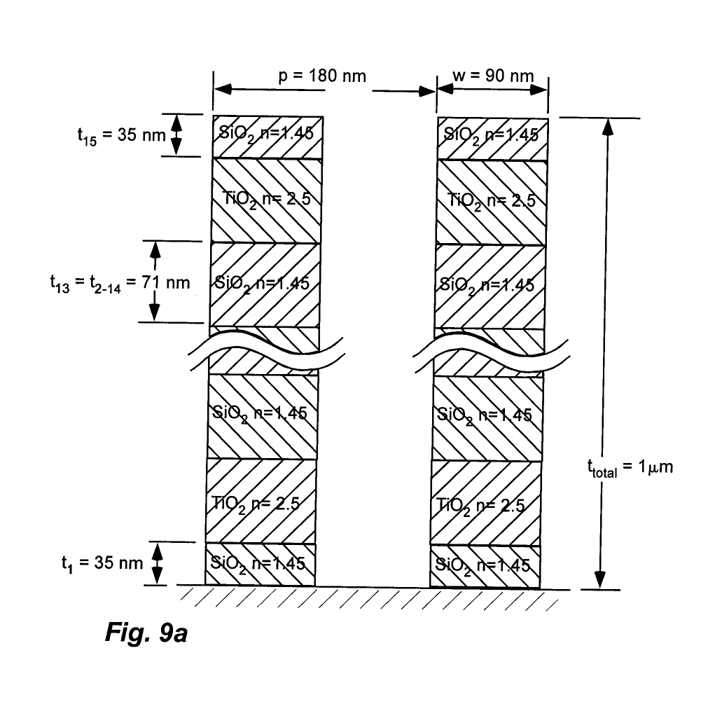

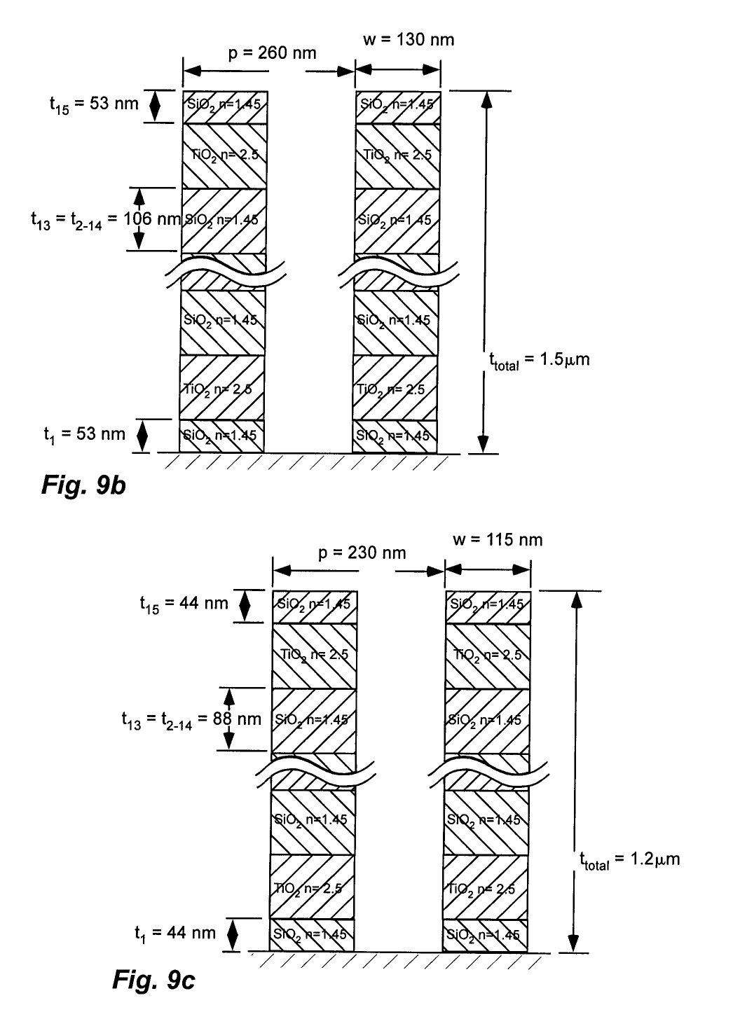

Referring to FIG. 9a, a first non-limiting example of an inorganic, dielectric grid polarizer is shown.

The grid polarizer has a stack of fifteen film layers disposed over a substrate. The film layers are formed of inorganic and dielectric materials, namely alternating layers of silicon dioxide (SiO₂)(n=1.45) and titanium dioxide (TiO₂)(n=2.5). The bottom layer and the top layer are silicon dioxide. Thus, the layers alternate between higher and lower indices of refraction (n). The top and bottom layers have a thickness (t₁ and t₁₅) of 35 nm, while the intervening layers have a thickness (t₂₋₁₄) of 71 nm. Thus, the entire stack has a thickness (tₜₒₜₐₗ) of approximately 1 μm or micron. All of the film layers are discontinuous and form an array 26 of parallel ribs 30. Thus, all of the layers are discontinuous to form form birefringent layers. The ribs have a pitch or period (p) of 180 nm, and a duty cycle (ratio of period to width) of 0.5 or width (w) of 90 nm.

Table 1 shows the calculated performance for the grid polarizer of FIG. 9a with incident light with a wavelength (λ) of 450 nm at angles of incidence of 30°, 45° and 60°.

TABLE 1
Example 1

| | Incident Angle | | |
|---|---|---|---|
| | 30 | 45 | 60 |
| | Wavelength | | |
| | 450 | | |
| p-transmission (Tp) | 98.43% | 99.18% | 95.33% |
| p-reflection (Rp) | 1.5622% | 0.8152% | 4.67% |
| s-transmission (Ts) | 0.1594% | 0.0517% | 0.0171% |
| s-reflection (Rs) | 99.84% | 99.94% | 99.98% |
| Efficiency (white)(TpRs) | 98.27% | 99.12% | 95.31% |
| Efficiency (black)(TpRp) | 1.54% | 0.81% | 4.45% |
| Contrast Transmission (T) | 618 | 1,920 | 5,575 |
| Contrast Reflection (R) | 64 | 123 | 21 |

From Table 1, it can be seen that the grid polarizer has excellent efficiency (TpRs). In addition, it can be seen that the transmission contrast varies with angle of incidence, exhibiting good contrast at 60° with a reduction in efficiency. At 45°, the grid polarizer has excellent efficiency and acceptable contrast for many applications.

### EXAMPLE 2

Referring to FIG. 9b, a second non-limiting example of an inorganic, dielectric grid polarizer is shown.

The grid polarizer has a stack of fifteen film layers disposed over a substrate. The film layers are formed of inorganic and dielectric materials, namely alternating layers of silicon dioxide (SiO₂)(n=1.45) and titanium dioxide (TiO₂)(n=2.5). The bottom layer and the top layer are silicon dioxide. Thus, the layers alternate between higher and lower indices of refraction (n). The top and bottom layers have a thickness (t₁ and t₁₅) of 53 nm, while the intervening layers have a thickness (t₂₋₁₄) of 106 nm. Thus, the entire stack has a thickness (tₜₒₜₐₗ) of approximately 1.5 μm or microns. All of the film layers are discontinuous and form an array 26 of parallel ribs 30. Thus, all of the layers are discontinuous to form form birefringent layers. The ribs have a pitch or period (p) of 260 nm, and a duty cycle (ratio of period to width) of 0.5 or width (w) of 130 nm.

Table 2 shows the calculated performance for the grid polarizer of FIG. 9b with incident light with a wavelength (λ) of 650 nm at angles of incidence of 30°, 45° and 60°.

TABLE 2
Example 2

| | Incident Angle | | |
|---|---|---|---|
| | 30 | 45 | 60 |
| | Wavelength | | |
| | 650 | | |
| p-transmission (Tp) | 98.53% | 99.74% | 96.66% |
| p-reflection (Rp) | 1.4685% | 0.2567% | 3.3318% |
| s-transmission (Ts) | 0.2315% | 0.0528% | 0.0133% |
| s-reflection (Rs) | 99.76% | 99.94% | 99.98% |
| Efficiency (white)(TpRs) | 98.29% | 99.68% | 96.64% |
| Efficiency (black)(TpRp) | 1.45% | 0.26% | 3.22% |
| Contrast Transmission (T) | 426 | 1,889 | 7,246 |
| Contrast Reflection (R) | 68 | 389 | 30 |

From Table 2, it can again be seen that the grid polarizer has excellent efficiency (TpRs). In addition, it can be seen that the transmission contrast varies with angle of incidence, exhibiting good contrast at 60° with a reduction in efficiency. At 45°, the grid polarizer has excellent efficiency and acceptable contrast for many applications.

### EXAMPLE 3

Referring to FIG. 9c, a third non-limiting example of an inorganic, dielectric grid polarizer is shown.

The grid polarizer has a stack of fifteen film layers disposed over a substrate. The film layers are formed of inorganic and dielectric materials, namely alternating layers of silicon dioxide (SiO₂)(n=1.45) and titanium dioxide (TiO₂)(n=2.5). The bottom layer and the top layer are silicon dioxide. Thus, the layers alternate between higher and lower indices of refraction (n). The top and bottom layers have a thickness (t₁ and t₁₅) of 44 nm, while the intervening layers have a thickness (t₂₋₁₄) of 88 nm. Thus, the entire stack has a thickness (tₜₒₜₐₗ) of approximately 1.2 μm or micron. All of the film layers are discontinuous and form an array 26 of parallel ribs 30. Thus, all of the layers are discontinuous to form form birefringent layers. The ribs have a pitch or period (p) of 230 nm, and a duty cycle (ratio of period to width) of 0.5 or width (w) of 115 nm.

Table 3 shows the calculated performance for the grid polarizer of FIG. 9c with incident light with a wavelength (λ) of 550 nm at angles of incidence of 30°, 45° and 60°.

TABLE 3
Example 3

| | Incident Angle | | |
|---|---|---|---|
| | 30 | 45 | 60 |
| | Wavelength | | |
| | 550 | | |
| p-transmission (Tp) | 97.93% | 99.02% | 95.81% |
| p-reflection (Rp) | 2.0656% | 0.9795% | 4.1840% |
| s-transmission (Ts) | 0.1325% | 0.0456% | 0.0000% |
| s-reflection (Rs) | 99.86% | 99.95% | 100% |
| Efficiency (white)(TpRs) | 97.79% | 98.97% | 95.81% |
| Efficiency (black)(TpRp) | 2.02% | 0.97% | 4.01% |
| Contrast Transmission (T) | 739 | 2,171 | Very high* |
| Contrast Reflection (R) | 48 | 102 | 24 |

*Difficult to accurately calculate.

From Table 3, it can be seen that the grid polarizer has excellent efficiency (TpRs). In addition, it can be seen that the transmission contrast varies with angle of incidence, exhibiting good contrast at 60° with a reduction in efficiency. At 45°, the grid polarizer has excellent efficiency and acceptable contrast for many applications.

From the above examples, it can be seen that the thicknesses of the layers can be tailored to a desired wavelength. It will be noted that the thickness of the layers increased for larger wavelengths. Similarly, it can be seen that the period can be increased for larger wavelengths. Furthermore, the above examples show that an effective visible grid polarizer can have a period less than 260 nm and can be operable over the visible spectrum.

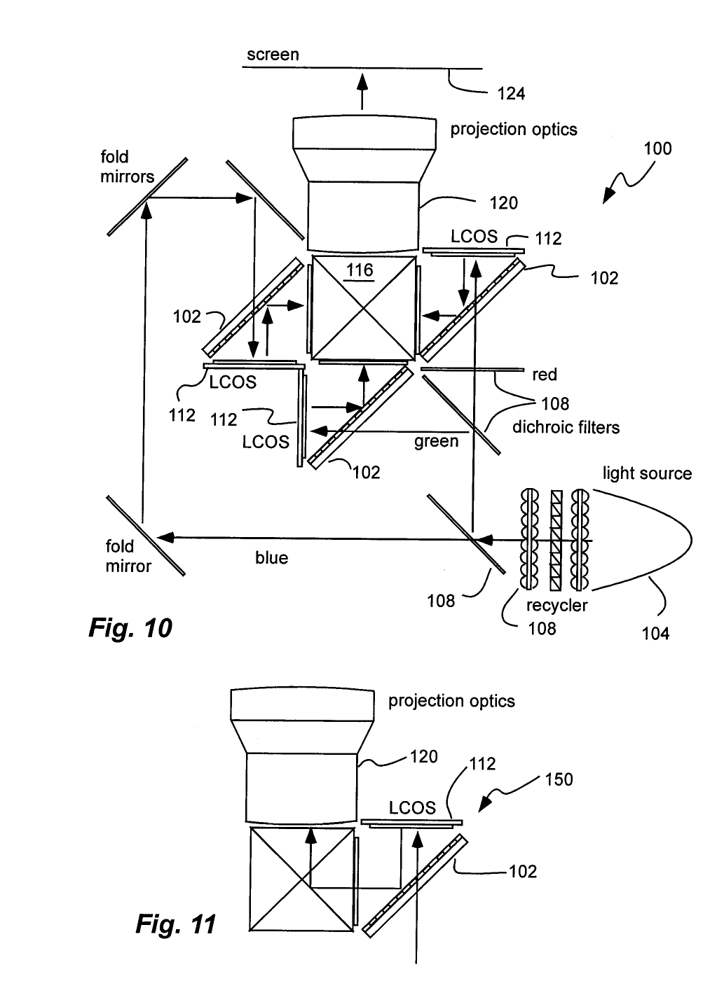

Referring to FIG. 10, a projection display system 100 utilizing inorganic, dielectric polarizing beam splitters 102 is shown in accordance with the present invention. The polarizing beam splitters 102 can be any described above. The system 100 includes a light source 104 to produce a light beam. The light beam can be any appropriate type, as known in the art, including an arc light, an LED array, etc. The beam can be treated by various optics, including beam shaping optics, recycling optics, polarizing optics, etc. (Various aspects of using a wire-grid polarizer in light recycling are shown in U.S. Pat. Nos. 6,108,131 and 6,208,463; which are herein incorporated by reference.) In addition, a light recycling system is described below. A polarizing beam splitter 102 may also be incorporated into the light recycling. One or more color separator(s) 108, such as dichroic filters, can be disposable in the light beam to separate the light beam into color light beams, such as red, green and blue.

At least one beam splitter 102 can be disposable in one of the color light beams to transmit a polarized color light beam. At least one reflective spatial light modulator 112, such as an LCOS panel, can be disposable in the polarized color light beam to encode image information thereon to produce an image bearing color light beam. The beam splitter 102 can be disposable in the image bearing color light beam to separate the image information and to reflect a polarized image bearing color light beam. As shown, three beam splitters 102 and three spatial light modulators 112 can be used, one for each color of light (blue, green, red). The polarized image bearing color light beams can be combined with an image combiner, such as an X-cube or recombination prism 116. Projection optics 120 can be disposable in the polarized image bearing color light beam to project the image on a screen 124.

The projection display system 100 can be a three-channel or three-color system which separates and treats three different color beams, such as red, green and blue, as described above. Thus, the system can use three polarizing beam splitters 102. The beam splitters 102 can be the same and can be configured to operate across the visible spectrum. Alternatively, two or more of the beam splitters 102 may be tuned to operate with a particular color or wavelength of light. For example, the display system 100 can have two or three different beam splitters (such as those similar to Examples 103 described above) each configured or tuned to operate with one or two colors or wavelengths.

The polarizing beam splitters 102 can face, or can have an image side that faces, the spatial light modulator 112. The facing or image side is opposite the substrate on which the wire-grid is disposed, or the side with the film layers. It is believed desirable to reflect the image from the grid side of the beam splitter to avoid distortion of the image beam that might occur with passing the image through the substrate.

The inorganic, dielectric grid polarizing beam splitter 102 of the present invention reduces heat transfer associated with conductive materials. Thus, it is believed that the beam splitter can be disposed adjacent to, or even abutting to, other components without transferring as much heat to those components. In addition, use of the beam splitter is believed to reduce thermal stress induced birefringence.

Referring to FIG. 11, it will be appreciated that the beam splitter 102 described above can be used in a subsystem of the projection display, such as a light engine or a modulation optical system 150, which includes the spatial light modulator 112 and beam splitter 102. Such a modulation optical system may also include a light source, color separators, beam shaping optics, light recycler, pre-polarizers, post-polarizers, and/or an x-cube. One or more modulation optical systems can be combined with other optics and components in a projection system.

As described above, the reflective spatial light modulator 112 can be configured to selectively encode image information on a polarized incident light beam to encode image information on a reflected beam. The beam splitter 102 can be disposed adjacent the reflective spatial light modulator to provide the polarized incident light beam to the reflective spatial light modulator, and to separate the image information from the reflected beam.

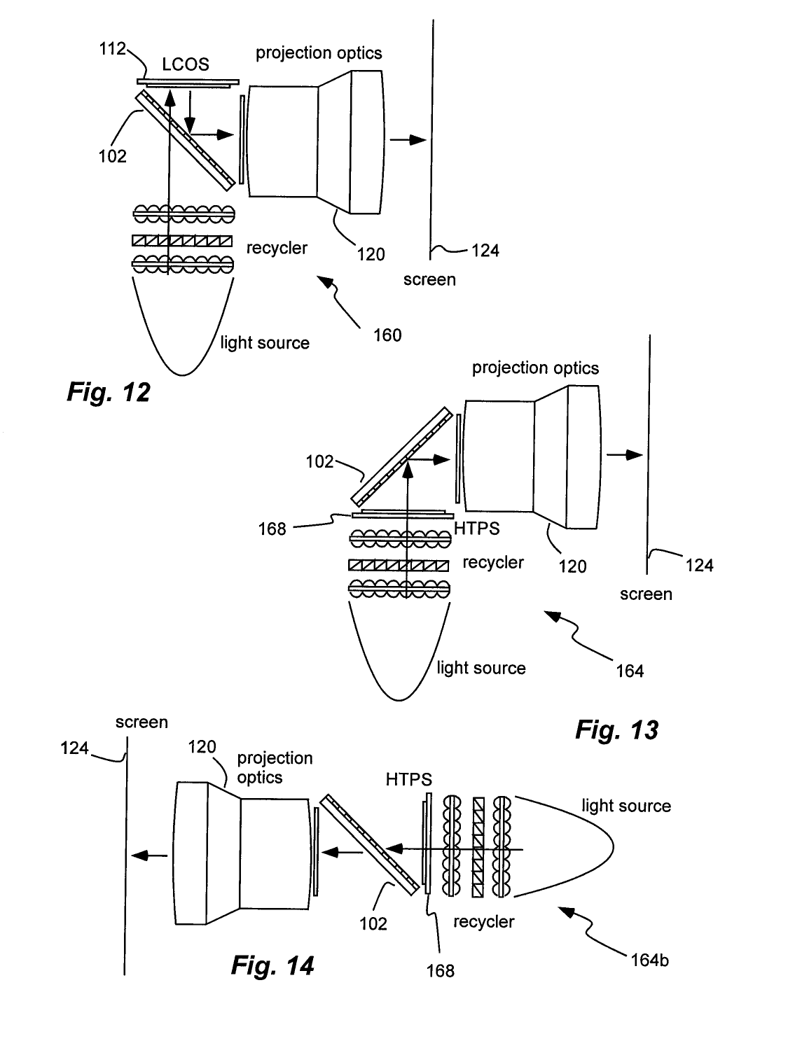

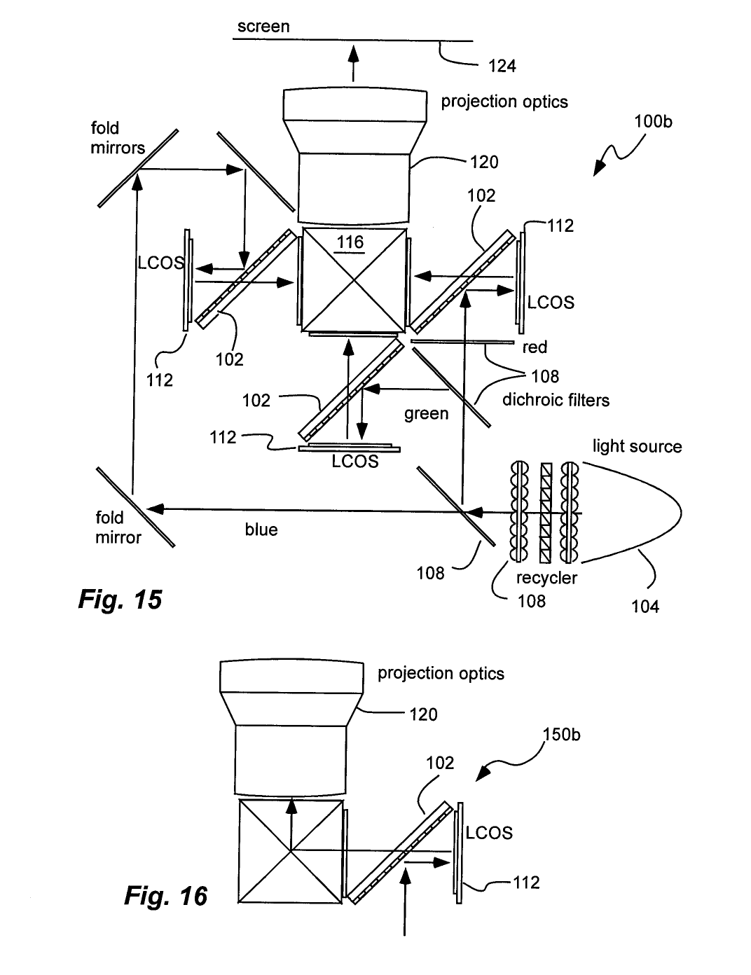

Although a three-channel, or three-color, projection system has been described above, it will be appreciated that a display system 150, 150b, 160, 164 or 164b can have a single channel, as shown in FIGS. 11-14 and 16. Alternatively, the single channels shown in FIGS. 11-14 and 16 can be modulated so that multiple colors are combined in a single channel. In addition, although the grid polarizer has been described above as being used with a reflective spatial light modulator, such as an LCOS panel (in FIGS. 10-12, 15 and 16), it will be appreciated that the grid polarizer can be used with a transmissive spatial light modulator 168, as shown in FIGS. 13 and 14. The transmissive spatial light modulator can be a high-temperature polysilicon (HTPS) panel.

Although a projection system and modulation optical system were shown in FIGS. 10-13 with the beam splitter in reflection mode (or with the image reflecting from the beam splitter), it will be appreciated that a projection system 100b or modulation optical system 150b or 164b can be configured with the beam splitter in transmission mode (or with the image transmitting through the beam splitter), as shown in FIGS. 14, 15 and 16.

Referring to FIG. 14, a projection system 164b is shown with a transmissive spatial light modulator 168 and a beam splitter 102 used in transmission mode (or with the image transmitted through the beam splitter). It is believed that such a configuration can take advantage of the improved transmission contrast of the beam splitter 102.

Various aspects of projection display systems with wire-grid polarizers or wire-grid polarizing beam splitters are shown in U.S. Pat. Nos. 6,234,634; 6,447,120; 6,666,556; 6,585,378; 6,909,473; 6,900,866; 6,982,733; 6,954,245; 6,897,926; 6,805,445; 6,769,779 and U.S. patent application Ser. Nos. 10/812,790; 11/048,675; 11/198,916; 10/902,319; which are herein incorporated by reference.

Although a rear projection system has been described herein it will be appreciated that a projection system can be of any type, including a front projection system.

The above descriptions of the grid polarizer and various applications have been directed to visible light (˜400 nm-˜700 nm). It will be appreciated, however, that a grid polarizer can be configured for use in infrared light (>˜700 nm) and ultra-violet light (<˜400 nm) and related applications. Such a grid polarizer can have a larger period and thicker layers.

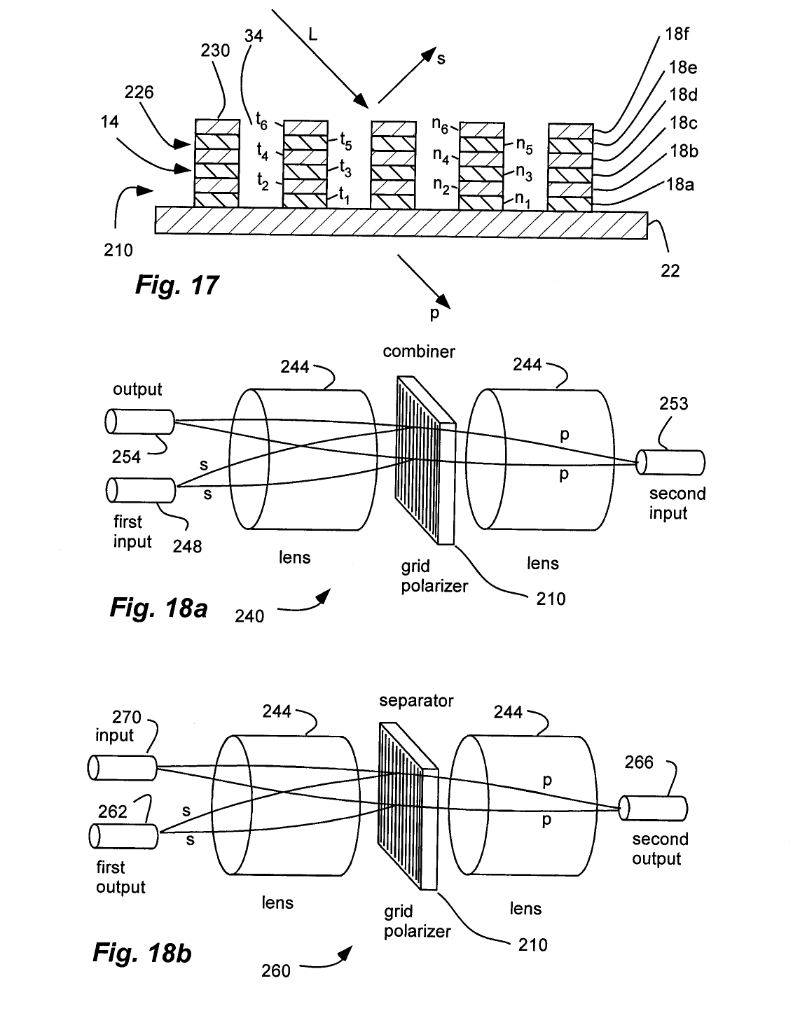

For example, referring to FIG. 17, an inorganic, dielectric grid polarizer 210 can be configured for use in infrared light, for applications such as telecommunications. The grid polarizer 210 is similar to those described above, and the above description is incorporated herein. The grid polarizer 210 has at least one film layer that is discontinuous to form a form birefringent layer with an array 226 of parallel ribs 230. The ribs have a pitch or period less than the wavelength being treated. For infrared applications (λ≈1300-1500 nm), such as telecommunication systems, the ribs can have a pitch or period less than 1 micron (1 μm or 1000 nm) in one aspect, or less than 0.4 microns (0.40 μm or 400 nm) in another aspect; but greater than 0.20 microns or micrometers (0.20 μm or 200 nm). Thus, an incident light beam L incident on the polarizer 210 separates the light into two orthogonal polarization orientations, with light having s-polarization orientation being reflected, and light having p-polarization orientation being transmitted or passed. (It is of course understood that the separation, or reflection and transmission, may not be perfect and that there may be losses or amounts of undesired polarization orientation either reflected and/or transmitted.) In addition, it will be noted that the array or grid of ribs with a pitch less than about half the wavelength of light does not act like a diffraction grating (which has a pitch about half the wavelength of light).

Such a grid polarizer 210 has low insertion loss, or little absorption. Thus, the grid polarizer 210 can be inserted into an optical train of a telecommunication application in which low insertion losses is important.

Referring to FIG. 18a, a combiner 240 is shown with a grid polarizer 210 described above. The combiner 200 includes a grid polarizer 210 as described above disposed between collimating/focusing lenses 244, such as graded index lenses, that can be oriented in a coaxial configuration so that their optical axes align to define an optical axis. First and second optical input fibers (or first and second optical beam carriers) 248 and 252 are disposed on opposite sides of the combiner and oriented parallel to the optical axis. An optical output fiber (or optical beam carrier) 254 is disposed adjacent to the first input fiber 248 at an end of the lens and oriented parallel to the optical axis. The fibers can be polarizing maintaining fibers. The first input fiber 248 can contain a polarized beam of s-polarization orientation while the second input fiber 252 can contain a polarized beam of p-polarization orientation. The grid polarizer 210 combines the beams into an output beam in the output fiber 254. The reflected beam and the transmitted beam combine to form a composite depolarized output beam having both polarization states.

Referring to FIG. 18b, a separator 260 is shown with a grid polarizer 210. The separator 260 includes a grid polarizer 210 as described above disposed between collimating/focusing lenses 244, such as graded index lenses, that can be oriented in a coaxial configuration so that their optical axes align to define an optical axis. First and second optical output fibers (or first and second optical beam carriers) 262 and 266 are disposed on opposite sides of the combiner and oriented parallel to the optical axis. An optical input fiber (or optical beam carrier) 270 is disposed adjacent to the first output fiber 262 at an end of the lens and oriented parallel to the optical axis. The fibers can be polarizing maintaining fibers. The input fiber 270 can contain an unpolarized beam. The grid polarizer 210 splits the beams into a reflected beam of s-polarization orientation directed towards the first output fiber, and a transmitted beam of p-polarization orientation directed towards the second output fiber.

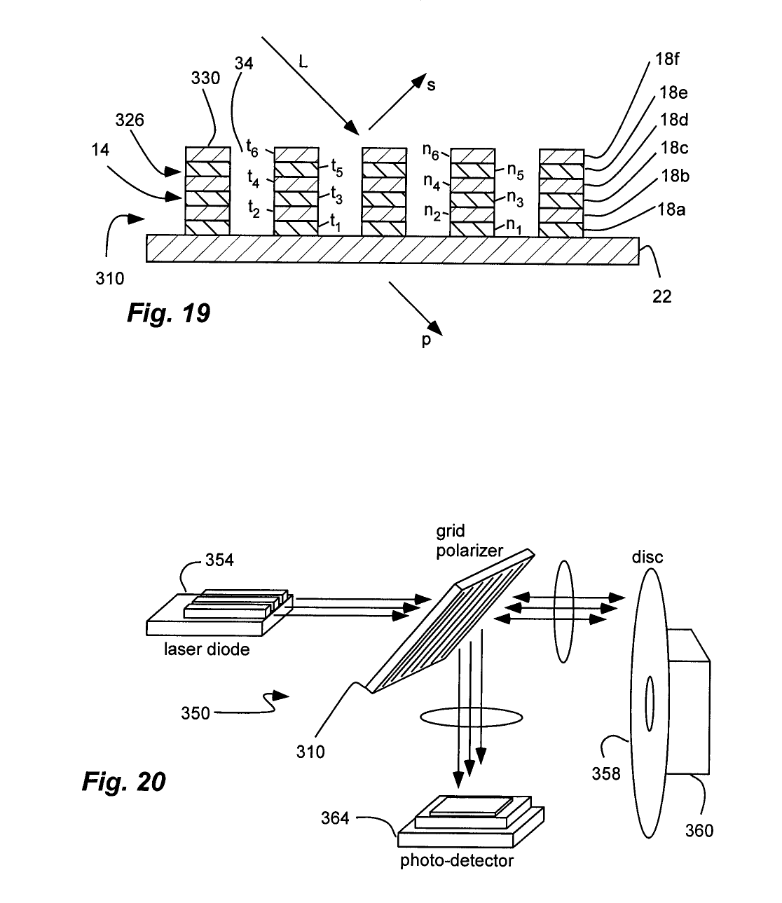

As another example, referring to FIG. 19, an inorganic, dielectric grid polarizer 310 can be configured for use in visible and/or near visible or near infrared, for applications such as optical drives or optical data storage. Data storage devices can include read only devices and read and write devices. Examples of such optical drives include compact disc (CD) drives, digital video disc (DVD) drives, high-density digital video disc (HD-DVD) blu-ray disc (BD) drives, etc. CD drives typically use 780 nm light. DVD drives typically use 650 nm light. HD-DVD or BD drives typically use 405 nm light. Combination drives can utilize all three wavelengths. The grid polarizer 310 is similar to those described above, and the above description is incorporated herein. The grid polarizer 310 has at least one film layer that is discontinuous to form a form birefringent layer with an array 326 of parallel ribs 330. For combination drives, the ribs can have a pitch or period less than 780 nm in one aspect, or less than 390 nm in another aspect. The grid polarizer 310 has low insertion loss.

Referring to FIG. 20, an optical data storage system 350 is shown including a grid polarizer 310 as described above. The data storage system can be configured to operate with one or more standard formats, including for example, compact disc (CD), digital video disc (DVD), high-density digital video disc (HD-DVD or Blu-Ray), or combinations of the above. A laser diode 354 can produce one or more light beams. The wavelength of the light beam can depend on desired use. For example, CDs commonly use light with 780 nm wavelength; DVDs commonly use light with 650 nm wavelength; and HD-DVD or Blu-Ray commonly use light with 405 nm wavelength. The laser diode can produce one or more, or all, of these wavelengths. The light beam is directed at a grid polarizer 310, which can polarizer the light, or pass polarized light beam. The grid polarizer 310 can be configured for use with the wavelength of the light produced by the laser diode. One or more grid polarizers 310 can be provided if more than one different wavelength of light is used. For example, the grid polarizers can have different periods configured for the wavelength used. The one or more grid polarizers 310 can have ribs with a pitch less than half of 780 nm, 650 nm and/or 405 nm. The light beam from the grid polarizer is incident on a disc medium 358, such as a plastic disc with an aluminum layer therein, as is known in the art. A motor or drive 360 can turn or rotate the disc medium 358. The light beam or laser diode can be moved radially across the disc medium as it is rotated. The disc medium 358 can reflect a modified light beam based on bumps in an aluminum layer in the disc, as known in the art, and can change the polarization orientation of the light beam. In addition, the disc medium can reflect a modified light beam based on dye in the disc, as is known in the art, and can change the polarization orientation of the light beam. The light beam reflected by the disc is directed towards the grid polarizer which separates the light beam based on polarization orientation. The separated light beam can be directed towards a photo-detector 364, as is known in the art. The photo-detector can be disposed in the reflected beam, as shown, or in the transmitted beam. In addition, various optics and lenses can treat or direct the beams.

A grid polarizer as described above can be used with a laser system, such as being disposed in a laser cavity. The grid polarizer has high heat tolerance. Such a laser system can produce highly polarized light. The laser system can be used in an image projection system.

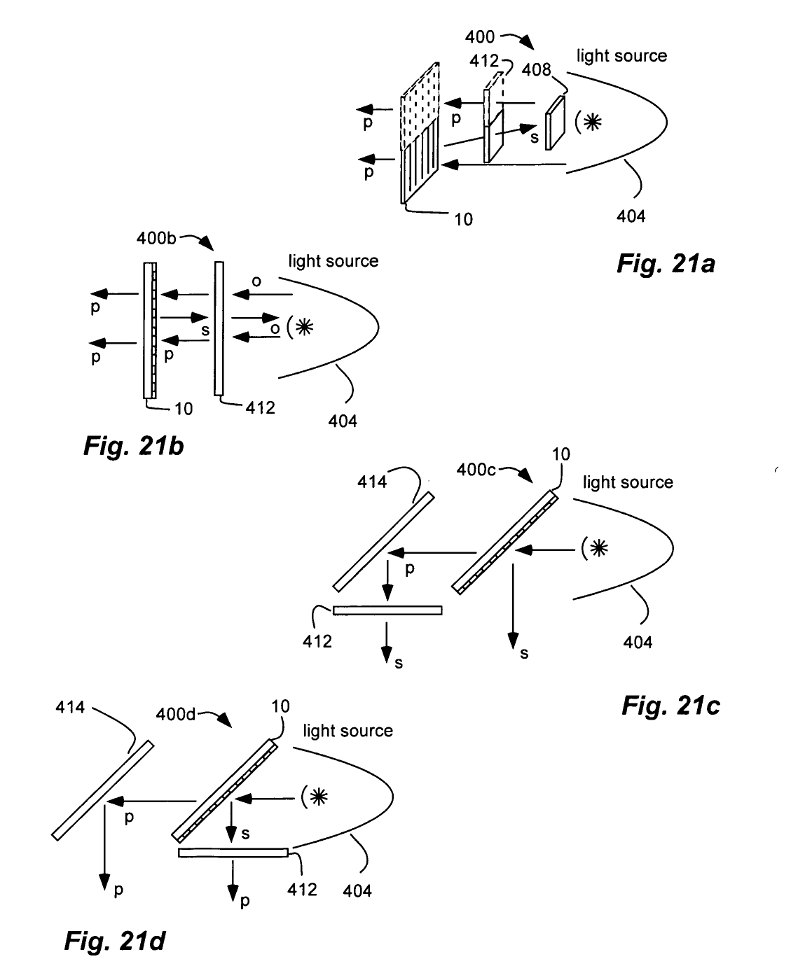

Grid polarizers described above can be utilized in a light recycling system. Such a light recycling system can be utilized in an image projection system described above. It will be appreciated that a beam of light includes two orthogonal polarization orientations that are separated by the grid polarizers described above. Thus, one polarization orientation, or approximately half of the light, might be discarded. A light recycling system described below can be employed to recover the other polarization orientation, thus utilizing more or all of the available light. Referring to FIG. 21a, a light recycling system 400 is shown utilizing a grid polarizer (represented by 10) as described above. The recycling system can include a light source 404 which can be of any type, including arc lamps, LED arrays, etc. In addition, the light source 404 can include a reflector. The light from the light source is directed towards the grid polarizer 10 which separates the polarization into two polarizations; reflecting the s-polarization orientation oriented parallel with the ribs, and transmitting p-polarization orientation oriented perpendicular to the ribs. The reflected polarization can be directed towards one or more reflectors 408, such as mirrors, and a light reorientation means 412, such as a wave plate, for changing the polarization orientation from s-polarization orientation to p-polarization orientation. The system can be configured so that the reflected light makes a single pass through the wave plate (illustrated by solid lines) then the wave plate can be a half wave plate. Alternatively, the system can be configured so that the reflected light makes two passes through the wave plate (illustrated by dashed lines) then the wave plate can be a quarter wave plate. Alternatively, the reflected light can be directed back to the reflector of the light source. After the light is converted from s-polarization to p-polarization, it can be directed in the same direction as the passed light beam and combined with the passed light beam to form a single beam of a single polarization orientation. The reflected and converted light can be passed through the grid polarizer (indicated by the dashed lines) or can bypass the grid polarizer.

Referring to FIG. 21b, another light recycling system 400b is shown utilizing a grid polarizer (represented by 10) as described above. Again, the light from the light source can be directed through a polarization reorientation means 412, such as a quarter wave plate, and to the grid polarizer 10. The reflected s-polarization orientation can be reflected back through the reorientation means to the light source which reflects it back through the reorientation means. After passing through the reorientation means, the light is converted from s-polarization orientation to p-polarization orientation and passes through the grid polarizer. Thus, substantially all the light has a single polarization orientation.

Referring to FIG. 21c, another light recycling system 400c is shown utilizing a grid polarizer (represented by 10) as described above. The light from the light source can be directed directly to the grid polarizer 10. The passes light of p-polarization orientation can be passed through a reorientation means 412, such as a half wave plate, to convert it to p-polarization orientation. Thus, substantially all the light has a single polarization orientation. In addition, both beams may be combined into a single beam, and/or directed in a common direction, such as by mirrors. In this configuration, light is not directed back to the light source.

Referring to FIG. 21d, another light recycling system 400d, is shown utilizing a grid polarizer (represented by 10) as described above. The system 400d is similar to that described in FIG. 21c, except that the reflected beam of s-polarization orientation is passed through the reorientation means 412 to convert it to p-polarization orientation.

Examples of light recycling systems are shown in U.S. Pat. Nos. 6,108,131; 6,208,463; 6,452,724; and 6,710,921; which are herein incorporated by reference.

With respect to FIGS. 21a-d, waveplates are examples of light reorientation means for changing the polarization orientation of the transmitted or reflected beam. In addition, mirrors and reflectors are examples light combination means for changing a direction of the transmitted or reflected beam so that both the transmitted beam and the reflected beam are combined and have the same direction.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A light recycling system, comprising:
a) a light source capable of producing a visible light beam;
b) an inorganic, dielectric grid polarizing beam splitter disposable in the light beam to separate the light beam into two light beams of orthogonal polarization orientation including a transmitted beam and a reflected beam, comprising:
i) a substrate;
ii) a stack of film layers disposed over the substrate;
iii) each film layer being formed of a material that is both inorganic and dielectric;
iv) adjacent film layers having different refractive indices including lower and higher refractive indices;
v) the bottom layer adjacent the substrate having a lower refractive index lss than a higher refractive index of an adjacent layer;
vi) at least one of the film layers being discontinuous to form a form birefringent layer with an array of parallel ribs with a period less than approximately 260 nm;
vii) at leat two adjacent film layers including a continuous layer covering the substrate and a discontinuous layer;
viii) the polarizer device consisting of only inorganic and dielectric materials; and
ix) at least one discontinuous layer being disposed intermediate the substrate and continuous layer;
c) light reorientation means disposable in the transmitted or reflected beam for changing the polarization orientation of the transmitted or reflected beam.

2. A system in accordance with claim 1, wherein the material of each film layer is optically transmissive to visible light.

3. A system in accordance with claim 2, wherein the material of each film layer has negligible absorption of visible light.

4. A system in accordance with claim 1, wherein the material of at least one of the film layers is naturally birefringent.

5. A system in accordance with claim 1, wherein the film layers alternate between higher and lower refractive indices.

6. (canceled)

7. A system in accordance with claim 1, wherein the polarizer device is formed without any organic or electrically conductive material.

8. A system in accordance with claim 1, wherein all of the film layers are discontinuous and form the array of parallel ribs.

9. A system in accordance with claim 1, wherein at least two adjacent film layers include a continuous layer and a discontinuous layer.

10. A system in accordance with claim 1, further comprising:
light combination means disposable in the transmitted or reflected beam for changing a direction of the transmitted or reflected beam so that both the transmitted beam and the reflected beam are combined and have the same direction.

11. A light recycling system, comprising:
a) a light source capable of producing a visible light beam;
b) an inorganic, dielectric grid polarizing beam splitter disposable in the light beam to separate the light beam into two light beams of orthogonal polarization orientation including a transmitted beam and a reflected beam, comprising:
i) a substrate;
ii) a stack of film layers disposed over the substrate including a bottom layer disposed adjacent the substrate;
iii) each film layer being formed of a material that is both inorganic and dielectric;
iv) adjacent film layers having different refractive indices including lower and higher refractive indices;
v) the bottom layer adjacent the substrate having a lower refractive index less than a higher refractive index of an adjacent layer;
vi) at least one of the film layers being discontinuous to form a form birefringent layer with an array of parallel ribs with a period less than approximately 260 nm;
vii) at least two adjacent film layers including a continuous layer covering the substrate and a discontinuous layer;
viii) the polarizer device consisting of only inorganic and dielectric materials; and
c) light combination means disposable in the transmitted or reflected beam for changing a direction of the transmitted or reflected beam so that both the transmitted beam and the reflected beam are combined and have the same direction.

12. A system in accordance with claim 11, wherein the material of each film layer is optically transmissive to visible light.

13. A system in accordance with claim 12, wherein the material of each film layer has negligible absorption of visible light.

14. A system in accordance with claim 11, wherein the material of at least one of the film layers is naturally birefringent.

15. A system in accordance with claim 11, wherein the film layers alternate between higher and lower refractive indices.

16. (canceled)

17. A system in accordance with claim 11, wherein the polarizer device is formed without any organic or electrically conductive material.

18. A system in accordance with claim 11, wherein all of the film layers are discontinuous and form the array of parallel ribs.

19. A system in accordance with claim 11, wherein at least two adjacent film layers include a continuous layer and a discontinuous layer.

20. A system in accordance with claim 11, further comprising:
light reorientation means disposable in the transmitted or reflected beam for changing the polarization orientation of the transmitted or reflected beam.

21. A light recycling system, comprising:
a) a light source capable of producing a visible light beam;
b) an inorganic, dielectric grid polarizing beam splitter disposable in the light beam to separate the light beam into two light beams of orthogonal polarization orientation including a transmitted beam and a reflected beam, comprising:
i) a substrate;
ii) a stack of film layers disposed over the substrate including a bottom discontinuous layer disposed adjacent the substrate;
iii) each film layer being formed of a material that is both inorganic and dielectric;
iv) adjacent film layers having different refractive indices including lower and higher refractive indices; and
v) the bottom layer adjacent the substrate having a lower refractive index less than a higher refractive index if an adjacent layer;
vi) at least one of the film layers being discontinuous to form a form birefringent layer with an array of parallel ribs with a period less than approximately 260 nm;
vii) at least two adjacent film layer include a continuous layer covering the substrate and discontinuous layer; and
viii) the polarizer device consisting of only inorganic and dielectric materials; and
c) light reorientation means disposable in the transmitted or reflected beam for changing the polarization orientation of the transmitted or reflected beam; and
d) light combination means disposable in the transmitted or reflected beam for changing a direction of the transmitted or reflected beam so that both the transmitted beam and the reflected beam are combined and have the same direction.

22. A system in accordance with claim 21, wherein the grid polarizing beam splitter further comprises: at least two adjacent film layers including a continuous layer covering the substrate and a discontinuous layer.

23. A device in accordance with claim 1, further comprising a plurality of ribs formed in and extending from the substrate.

24. A device in accordance with claim 1, wherein the stack of film layers includes top and bottom layers and intervening layers; and wherein the bottom layer has a thickness less than a thickness of the intervening layers.

25. A device in accordance with claim 11, further comprising a plurality of ribs formed in and extending from the substrate.

26. A device in accordance with claim 11, wherein the stack of film layers includes top and bottom layers and intervening layers; and wherein the bottom layer has a thickness less than a thickness of the intervening layers.
